(19) United States
(12) Patent Application Publication
(10) Pub. No.: US 2023/0348217 A1
(43) Pub. Date: Nov. 2, 2023

(54) IMAGE FORMING APPARATUS THAT INCREASES ROTATION SPEED OF TRANSPORT ROLLER PAIR, FOR PREDETERMINED PERIOD AFTER DETECTING ARRIVAL OF RECORDING MEDIUM AT PREDETERMINED DETECTING POSITION

(71) Applicant: KYOCERA Document Solutions Inc., Osaka (JP)

(72) Inventor: Hironori DAIGO, Osaka (JP)

(73) Assignee: KYOCERA Document Solutions Inc., Osaka (JP)

(21) Appl. No.: 18/136,182

(22) Filed: Apr. 18, 2023

(30) Foreign Application Priority Data
Apr. 28, 2022 (JP) 2022-074694

(51) Int. Cl. B65H 5/06

(52) U.S. Cl. CPC B65H 5/062; B65H 2513/10

(57) ABSTRACT

An image forming apparatus includes an image forming device, a transport member, a transport roller pair, an arrival sensor, a first drive source, a second drive source, and a controller. The transport roller pair is located downstream of the printing position in a transport direction of the recording medium, at a position where a leading edge in the transport direction, of the recording medium passing through the printing position, enters into the nip region. The controller sets the rotation speed of the transport member and the transport roller pair to predetermined first rotation speed, and sets the rotation speed of the drive roller to predetermined second rotation speed faster than the first rotation speed, for a predetermined period after the arrival sensor has detected the arrival of the recording medium, transported at the first rotation speed by the transport member, at the detecting position.

### INCORPORATION BY REFERENCE

This application claims priority to Japanese Patent Application No. 2022-074694 filed on Apr. 28, 2022, the entire contents of which are incorporated by reference herein.

### BACKGROUND

The present disclosure relates to an image forming apparatus, and in particular to a technique to prevent degradation of image quality.

An image forming apparatus, such as a copier or a multifunction peripheral, may suffer image degradation such as a color shift, owing to fluctuation in transport speed of the recording medium. To minimize such a drawback, for example, a technique has been developed to suppress the image degradation, by forming a warp (loop) in the recording sheet, serving as the recording medium, thereby allowing the recording sheet itself to absorb the fluctuation in transport speed of the recording sheet.

### SUMMARY

The disclosure proposes further improvement of the foregoing techniques.

In an aspect, the disclosure provides image forming apparatus including an image forming device, a transport member, a transport roller pair, an arrival sensor, a first drive source, a second drive source, and a controller. The image forming device forms an image on a recording medium, at a predetermined printing position. The transport member transports the recording medium through the printing position. The transport roller pair includes a drive roller, and a follower roller that defines a nip region in collaboration with the drive roller, and transports the recording medium by holding the recording medium in the nip region. The arrival sensor detects arrival of the recording medium at a predetermined detecting position, where the recording medium is immediately before entering into the nip region. The first drive source drives the transport member. The second drive source is connected to a drive roller, and drives the transport roller pair. The second drive source is independent from the first drive source. The controller controls rotation speed of the transport member and the transport roller pair, by controlling operation of the first drive source and the second drive source. The transport roller pair is located downstream of the printing position in a transport direction of the recording medium, at a position where a leading edge in the transport direction, of the recording medium passing through the printing position, enters into the nip region. The controller sets the rotation speed of the transport member and the transport roller pair to predetermined first rotation speed, and sets the rotation speed of the drive roller to predetermined second rotation speed faster than the first rotation speed, for a predetermined period after the arrival sensor has detected the arrival of the recording medium, transported at the first rotation speed by the transport member, at the detecting position.

### BRIEF DESCRIPTION OF THE DRAWINGS

FIG. 1 is a functional block diagram schematically showing an essential internal configuration of an image forming apparatus;

FIG. 2 is a schematic front view showing an image forming device and related components;

FIG. 3 is a front view showing a delivery transport unit;

FIG. 4 is a perspective view showing the delivery transport unit;

FIG. 5 is a right side view of the delivery transport unit;

FIG. 6 is a flowchart showing an exemplary rotation speed adjusting operation;

FIG. 7A and FIG. 7B are graphs each showing a relation between an elapsed time, and rotation speed of a roller and transport speed of a recording sheet; and

FIG. 8 is a conceptual drawing for explaining a color shift that takes place on the recording sheet.

### DETAILED DESCRIPTION

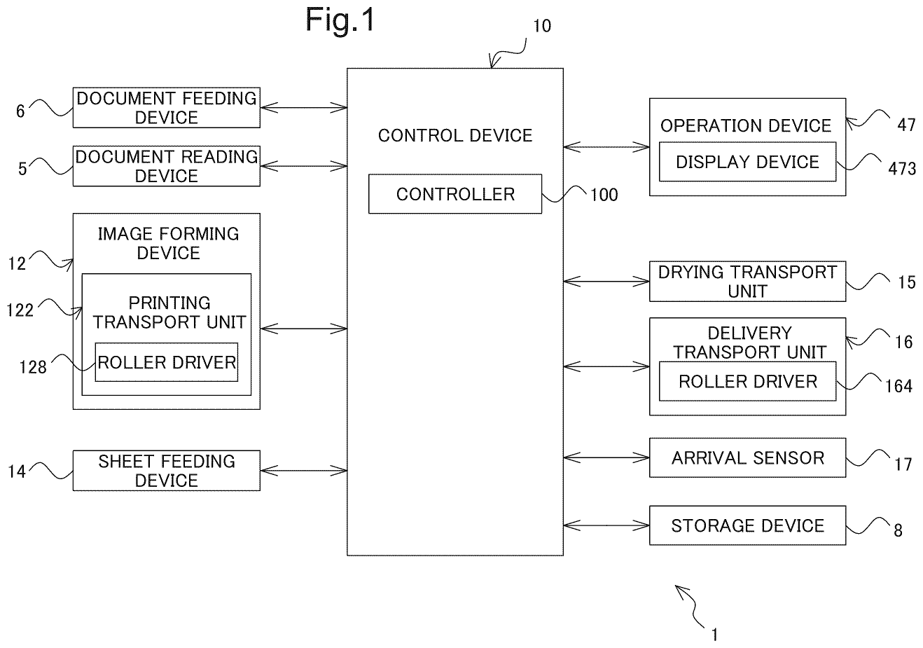

Hereafter, an image forming apparatus according to an embodiment of the disclosure will be described, with reference to the drawings. FIG. 1 is a functional block diagram schematically showing an essential internal configuration of the image forming apparatus 1 according to the embodiment of the disclosure.

The image forming apparatus 1 is a multifunction peripheral having a plurality of functions, such as copying, printing, scanning, and facsimile transmission. The image forming apparatus 1 includes a control device 10, a document feeding device 6, a document reading device 5, an image forming device 12, a sheet feeding device 14, a drying transport unit 15, a delivery transport unit 16, an arrival sensor 17, an operation device 47, and a storage device 8.

The document feeding device 6 is openably connected to the upper face of the document reading device 5, for example via a hinge. The document feeding device 6 serves as a document retention cover, when the document reading device 5 reads a source document placed on the platen glass. The document feeding device 6 is an automatic document feeder, abbreviated as ADF. The document feeding device 6 includes a document tray, and delivers the source documents placed thereon one by one, to the document reading device 5.

To perform the document reading operation, the image forming apparatus 1 operates as follows. The document reading device 5 optically reads the image on the source document delivered from the document feeding device 6 to the document reading device 5, or placed on the platen glass, and generates image data. The image data generated by the document reading device 5 is stored, for example, in an image memory.

To perform the image forming operation, the image forming apparatus 1 operates as follows. The image forming device 12 forms an image by ink jet printing, on a recording sheet P serving as a recording medium, and delivered from the paper feeding device 14, on the basis of the image data generated through the document reading operation, image data stored in the image memory, or image data received from a computer connected via the network. The sheet feeding device 14 includes a sheet cassette for storing the recording sheets P.

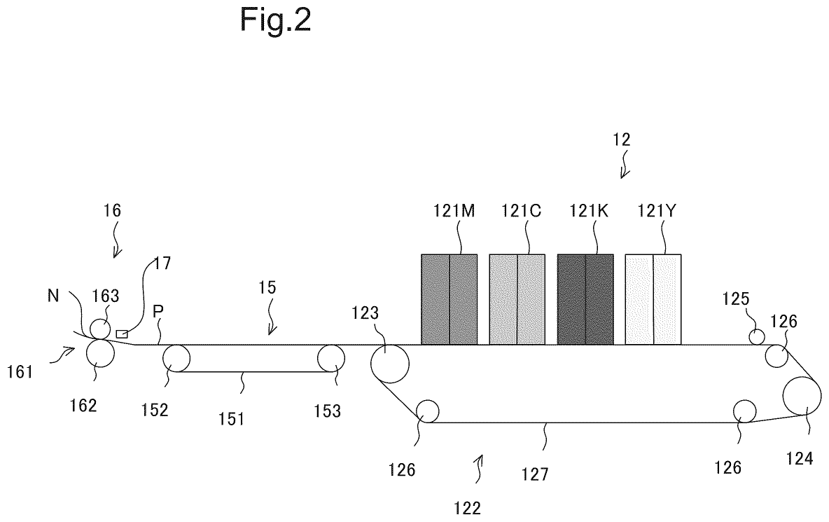

FIG. 2 is a schematic front view showing the image forming device 12 and the related components. The image forming device 12 includes ink heads 121M, 121C, 121K, and 121Y (hereinafter collectively referred to as “ink head 121”) that respectively eject ink droplets of four colors (magenta, cyan, black, and yellow), and a printing transport unit 122. The image forming device 12 forms an image on the recording sheet P (exemplifying the recording medium in the disclosure) at a predetermined printing position, thus executing the printing operation.

The printing transport unit 122 includes a drive roller 123, a follower roller 124, an adsorption roller 125, a plurality of tension rollers 126, a transfer belt 127, and a roller driver 128 (see FIG. 1). The transfer belt 127 is an endless belt serving to transport the recording sheet P opposed to the ink head 121. In other words, the transfer belt 127 transports the recording sheet P through the printing position. The transfer belt 127 is stretched around the drive roller 123, the follower roller 124, and the plurality of tension rollers 126. The transfer belt 127 exemplifies the transport member in the disclosure.

The drive roller 123 is driven by the roller driver 128, to rotate counterclockwise in FIG. 2. The roller driver 128 includes a motor and gears. The roller driver 128 acts as a drive source that supplies rotative driving force to the drive roller 123. When the drive roller 123 is driven to rotate, the transfer belt 127 runs counterclockwise, and also the follower roller 124 and the tension roller 126 are made to rotate counterclockwise. The roller driver 128 exemplifies the first drive source in the disclosure.

The tension roller 126 serves to maintain the tension of the transfer belt 127 at an appropriate level. The adsorption roller 125 electrically charges the transfer belt 127, to thereby electrostatically adsorb the recording sheet P supplied from sheet feeding device 14, to the transfer belt 127. The transfer belt 127 includes a plurality of suction holes. A negative pressure generator located on the lower side of the transfer belt 127 applies negative pressure to the recording sheet P through the suction holes, to thereby adsorb the recording sheet P to the transfer belt 127.

The drying transport unit 15 and the delivery transport unit 16 are located downstream of the printing position, where the image forming device 12 executes the printing operation, in the transport direction. The recording sheet P, on which the image has been formed by the image forming device 12, passes through the drying transport unit 15 and the delivery transport unit 16 in a face-up orientation (printed face oriented upward), and delivered to an output tray.

The drying transport unit 15 serves to naturally dry the ink on the recording sheet P, while transporting the recording sheet P. The drying transport unit 15 includes an endless transfer belt 151, and a pair of rollers 152 and 153. Here, the drying transport unit 15 is not a mandatory component, but may be omitted.

The delivery transport unit 16 includes a transport roller pair 161 and a roller driver 164 (see FIG. 1). The transport roller pair 161 is composed of a drive roller 162 and a follower roller 163. The follower roller 163 is opposed to the drive roller 162, and defines a nip region N for holding the recording sheet P in collaboration with the drive roller 162. The transport roller pair 161 transports the recording medium held in the nip region. The roller driver 164 exemplifies the second drive source in the disclosure.

The delivery transport unit 16 is located at the position where the leading edge in the transport direction, of the recording sheet P passing through the printing position, enters into the nip region.

The drive roller 162 is located on the lower side of the follower roller 163. Since the recording sheet P is transported in the face-up orientation, the drive roller 162 is kept from contacting the recording sheet P via the printed face, but the follower roller 163 contacts the recording sheet P via the printed face. The roller driver 164 includes a motor and gears. The roller driver 164 acts as a drive source that supplies rotative driving force to the drive roller 162. The roller driver 164 is independent from the roller driver 128 acting as the drive source for the drive roller 123. In other words, the drive source for the drive roller 162 is independent from the drive source employed for transporting the recording sheet P passing through the printing position.

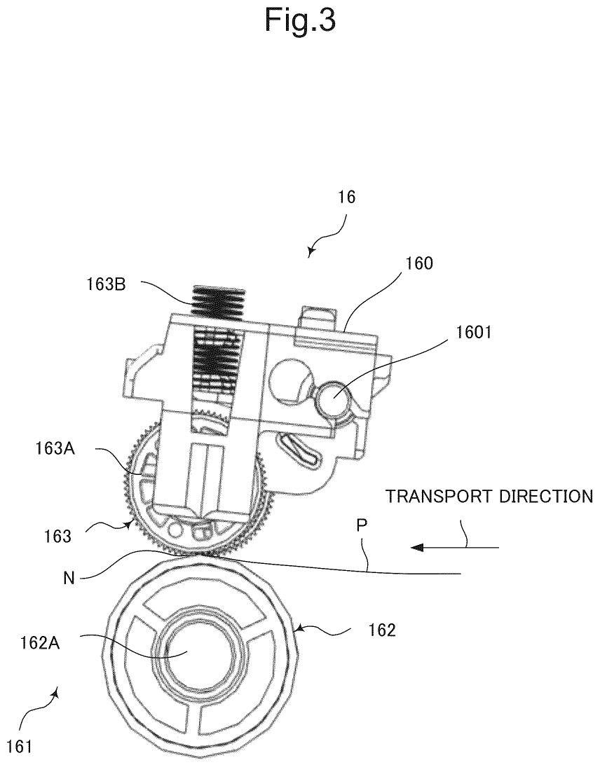

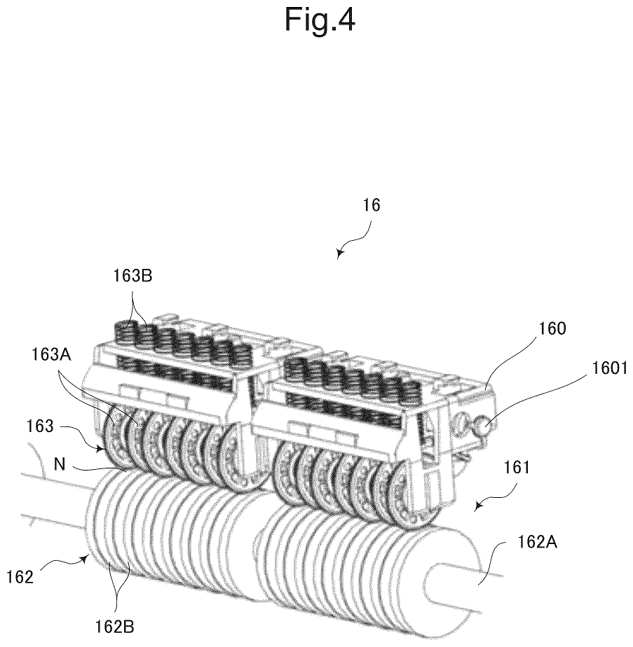

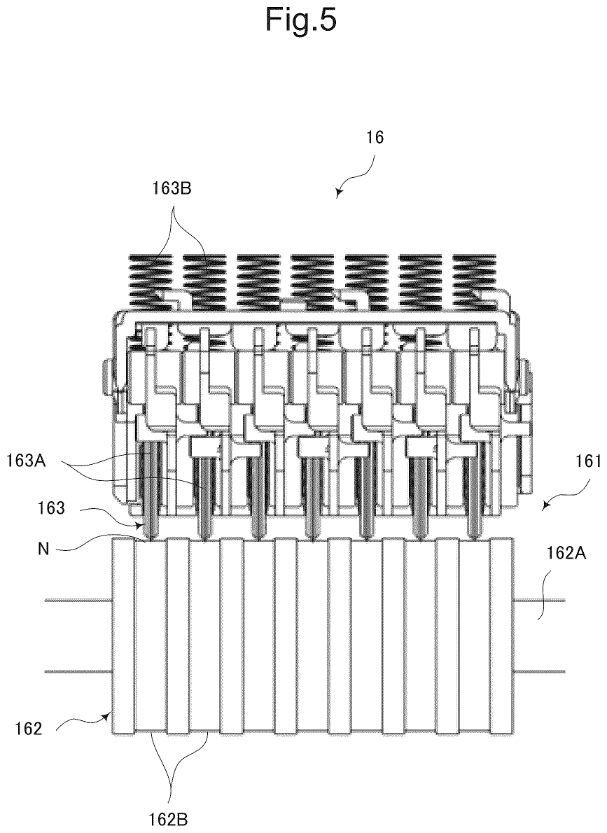

FIG. 3 is a front view showing the delivery transport unit 16. FIG. 4 is a perspective view showing the delivery transport unit 16. FIG. 5 is a right side view of the delivery transport unit 16.

A rotary shaft 162A of the drive roller 162 is longer than the size of the recording sheet P in the width direction. The end portions of the rotary shaft 162A are each rotatably supported by a support member located on the respective outer sides of the recording sheet P in the width direction. The gear of the roller driver 164 is attached to one end portion of the rotary shaft 162A, to transmit the driving force from the motor.

The drive roller 162 includes a plurality of annular grooves 162B, formed on the outer circumferential surface in the circumferential direction. The annular grooves 162B are aligned along the longitudinal direction of the rotary shaft 162A of the drive roller 162, with a spacing between each other.

The follower roller 163 includes a plurality of rotating bodies 163A that each rotate about the rotary shaft of the follower roller 163. The rotating body 163A is a thin component, having a thickness that allows the outer circumferential portion to fit in the annular groove 162B. The rotating bodies 163A are opposed to the respective annular grooves 162B, so as to define the nip region N with the annular grooves 162B.

The rotating bodies 163A are each biased toward the drive roller 162, by a biasing member 163B, so that the nip region N is defined between the drive roller 162 and the follower roller 163.

The arrival sensor 17 shown in FIG. 1 and FIG. 2 detects the arrival of the recording sheet P, at a predetermined detecting position where the recording sheet P is immediately before entering into the nip region N. The arrival sensor 17 is located close to the nip region N. The predetermined detecting position may be set, for example, at a closest possible position from the nip region N, where the arrival sensor 17 can detect the leading edge of the recording sheet P in the transport direction, or at a position close to the transport roller pair 161, in the region between the roller closest to the transport roller pair 161 and upstream thereof in the transport direction of the recording sheet, and the transport roller pair 161. The arrival sensor 17 may be, for example, a known optical sensor including a light emitting element, and a photodetector that receives the light emitted from the light emitting element. The arrival sensor 17 detects that the leading edge of the recording sheet P has reached the detecting position, when the photodetector, which has been continuously receiving the light from the light emitting element, has stopped receiving the light from the light emitting element.

The operation device 47 includes various physical keys, and a touch panel. The operation device 47 receives the user's instructions to execute the functions and operations that the image forming apparatus 1 is configured to perform, such as the image forming operation. The operation device 47 includes a display device 473 for displaying, for example, an operation guide for the user. The operation device 47 receives, through a touch panel provided on the display device 473, the user's instruction based on an operation (touch operation) performed by the user on the operation screen displayed on the display device 473. The operation device 47 also receives an input of the user's instruction, according to the user's operation performed on a physical key provided in the operation device 47.

The display device 473 includes, for example, a liquid crystal display (LCD). The display device 473 includes the touch panel. When the user touches a button or a key displayed on the screen, the touch panel receives the instruction corresponding to the touched position.

The storage device 8 is a large-capacity storage device such as a hard disk drive (HDD) and a solid state drive (SSD). The storage device 8 contains various control programs.

The control device 10 includes a processor, a random-access memory (RAM), a read-only memory (ROM), and an exclusive hardware circuit. The processor is, for example, a central processing unit (CPU), an application specific integrated circuit (ASIC), or a micro processing unit (MPU).

The control device 10 acts as a controller 100, when the processor operates according to the control program stored in the storage device 8. Here, the controller 100 may be constituted in the form of a hardware circuit, instead of being realized by the operation of the control device 10 according to the control program. This also applies to other embodiments, unless otherwise specifically noted.

The controller 100 serves to control the overall operation of the image forming apparatus 1. The controller 100 is connected to the document feeding device 6, the document reading device 5, the image forming device 12, the sheet feeding device 14, the drying transport unit 15, the delivery transport unit 16, the arrival sensor 17, the operation device 47, and the storage device 8, and controls the operation of the mentioned components. For example, the controller 100 controls the operation of the image forming device 12, to form an image on the recording sheet P delivered from the sheet feeding device 14, thus executing a printing job.

The controller 100 controls the nip pressure of the nip region N, depending on the type of the recording sheet P. For example, the controller 100 increases the nip pressure, with an increase in thickness of the recording sheet P, inputted by the user. The controller 100 performs such adjustment of the nip pressure, for example, by controlling the action of a known mechanism for moving the drive roller 162 and the follower roller 163 toward and away from each other (e.g., a mechanism that causes a support member 160, rotatably supporting the follower roller 163 at the respective end portions of the rotary shaft thereof, to pivot about a pivotal shaft 1601).

The controller 100 also adjusts the rotation speed of the drive roller 162, by controlling the movement of the transport roller pair 161. To be more specific, the controller 100 adjusts the rotation speed of the drive roller 162, by controlling the roller driver 164. For example, the controller 100 controls the movement of the transport roller pair 161, so as to transport the recording sheet P at a predetermined first rotation speed, which is the sheet transport speed in an ordinary printing operation. The controller 100 increases rotation speed of the drive roller 162 to a predetermined second rotation speed, faster than the first rotation speed, for a predetermined period after the arrival sensor 17 has detected the arrival of the recording sheet P at the detecting position, in other words after the recording sheet P has entered into the nip region N. The controller 100 also adjusts the rotation speed of the transfer belt 127, for example to the first rotation speed, by controlling the action of the roller driver 128.

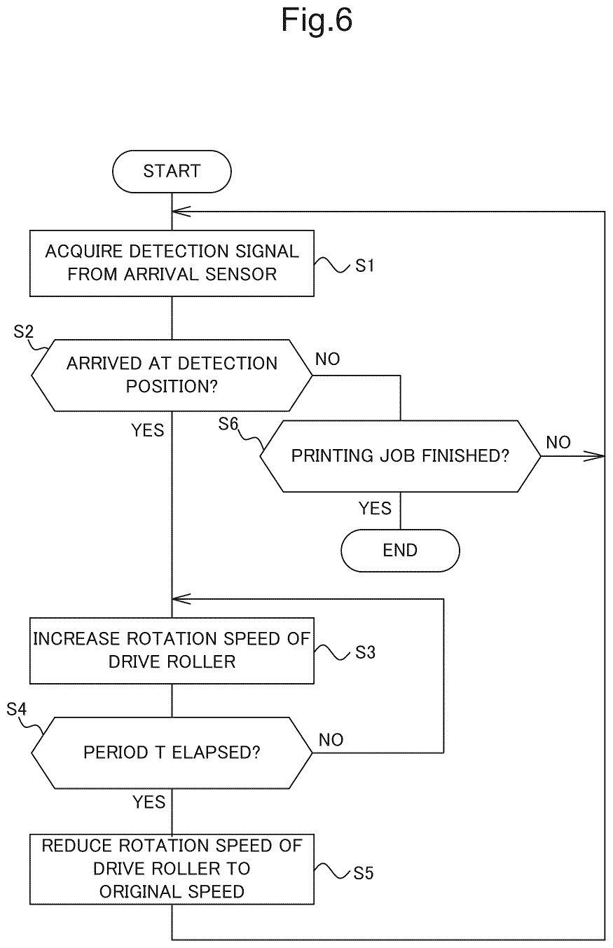

Referring now to a flowchart shown in FIG. 6, an example of a rotation speed adjusting operation, performed by the control device 10 of the image forming apparatus 1, will be described hereunder. The controller 100 performs the rotation speed adjusting operation, while executing the printing job.

The controller 100 acquires a detection signal indicating whether the leading edge of the recording sheet P has been detected, from the arrival sensor 17 (step S1). The controller 100 decides whether the recording sheet P has reached the predetermined detecting position (corresponding to the location of the arrival sensor 17), where the recording sheet P is immediately before entering into the nip region N (step S2). Upon deciding that the recording sheet P has reached the detecting position (YES at step S2), the controller 100 controls the roller driver 164, to increase the rotation speed of the drive roller 162 to the second rotation speed (step S3). For example, the controller 100 sets the second rotation speed, to a speed faster than the first rotation speed by 0.1 to 8.0%.

Then the controller 100 decides whether a predetermined period T has elapsed, after the time point that the recording sheet P reached the detecting position (i.e., that the rotation speed of the drive roller 162 was increased) (step S4). For example through experimental measurements, a speed reduction period, in which the transport speed of the recording sheet P by the transport roller pair 161 is reduced, because of the leading edge of the recording sheet P reaching the nip region N and colliding with the drive roller 162 and the follower roller 163, can be determined in advance. The controller 100 sets the predetermined period T, to the period from the time point that the arrival sensor 17 detected the leading edge of the recording sheet P, until the end of the speed reduction period, or until a time point beyond the end by a predetermined time. Thus, the controller 100 controls the movement of the transport roller pair 161 by increasing the rotation speed of the drive roller 162, to the second rotation speed for the predetermined period after the arrival sensor 17 detected the arrival of the recording sheet P at the detecting position, in other words after the recording sheet P entered into the nip region N.

Upon deciding that the period T has elapsed (YES at step S4), the controller 100 controls the roller driver 164, to set the rotation speed of the drive roller 162 back to the first rotation speed, which is the original speed (step S5). Then the controller 100 returns to step S1. In contrast, upon deciding that the period T has not elapsed yet (NO at step S4), the controller 100 returns to step S3.

Upon deciding that the recording sheet P has not reached the detecting position (NO at step S2), the controller 100 decides whether the printing job has been finished (step S6). Upon deciding that the printing job has been finished (YES at step S6), the controller 100 finishes the rotation speed adjusting operation. In contrast, upon deciding that the printing job has not been finished yet (NO at step S6), the controller 100 returns to step S1.

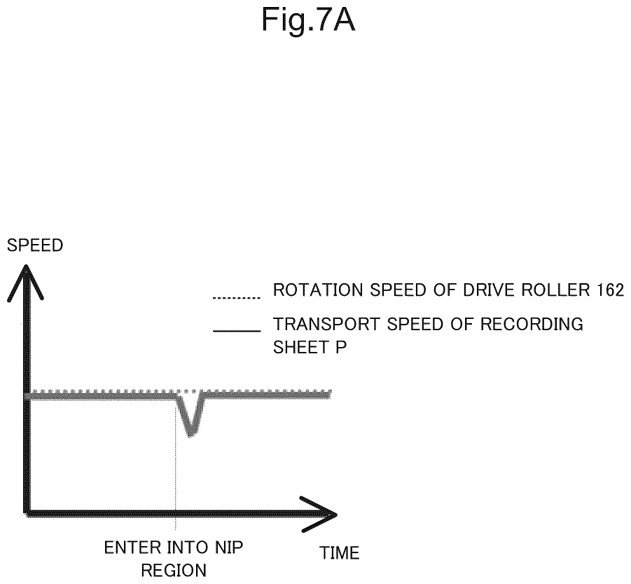

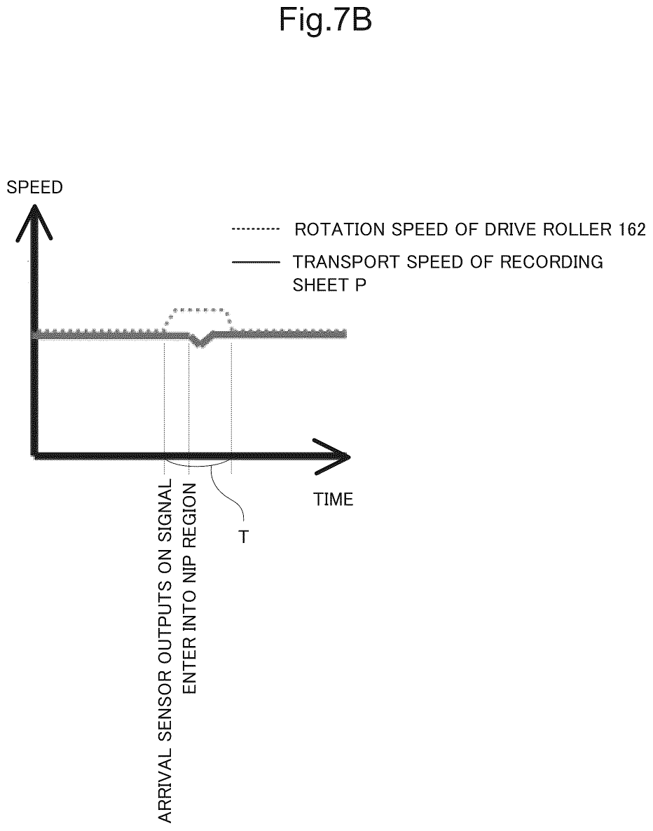

FIG. 7A and FIG. 7B are graphs each showing a relation between the elapsed time, and the rotation speed of the drive roller 162 and the transport speed of the recording sheet P. FIG. 7A represents the case of an existing apparatus not configured to adjust the rotation speed of the drive roller 162. FIG. 7B represents the case of this embodiment, in which the rotation speed of the drive roller 162 is adjusted. In FIG. 7A and FIG. 7B, broken lines represent the rotation speed of the drive roller 162, and solid lines represent the transport speed of the recording sheet P.

In the case where the rotation speed of the drive roller 162 is not adjusted, the transport speed of the recording sheet P largely fluctuates as shown in FIG. 7A, when the recording sheet P enters into the nip region N. On the other hand, in the case where the rotation speed of the drive roller 162 is increased, until the period T elapses after time point that the detection signal from the arrival sensor 17 has been switched from an OFF signal indicating that the leading edge of the recording sheet P has not been detected, to an ON signal indicating that the leading edge of the recording sheet P has been detected (i.e., time point that the leading edge of the recording sheet P has reached the detecting position), the recording sheet transport speed barely fluctuates as shown in FIG. 7B, despite the recording sheet P having entered into the nip region N.

Now, the image forming apparatuses, provided with the transport roller pair for transporting the recording sheet, are widely known. The transport roller pair is located downstream in the transport direction, of the printing position where an image is formed on the recording sheet. When the recording sheet enters into the nip region defined by the transport roller pair, the leading edge of the recording sheet is subjected to a load from the impact of the collision, which may lead to reduction in transport speed of the recording sheet. This would not cause a problem if the trailing edge of the recording sheet has already left the printing position at this point. However, when a part of the recording sheet still remains in the printing position, image degradation such as color shift may be incurred.

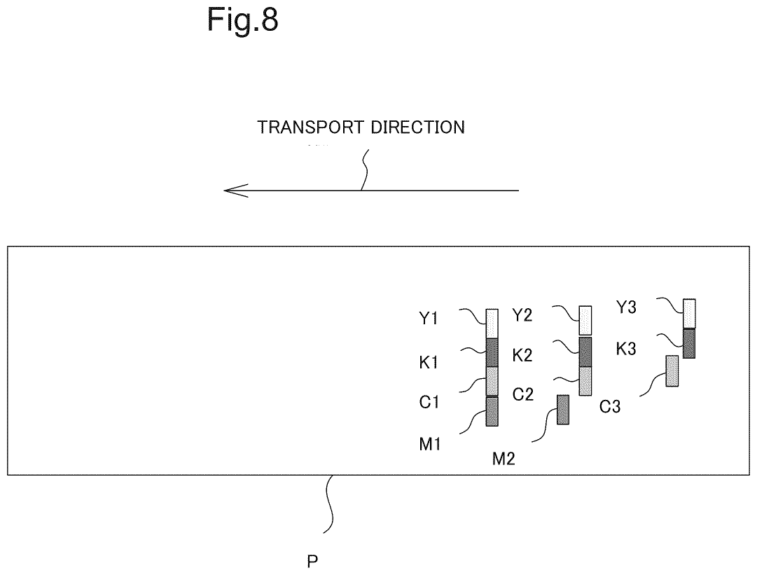

FIG. 8 is a conceptual drawing for explaining the color shift that takes place on the recording sheet. Dots Y1 to Y3, dots K1 to K3, dots C1 to C3, and dots M1 and M2 respectively represent the dots of yellow, black, cyan, and magenta. When the recording sheet P is free from the color shift, the dots Y2, K2, C2, and M2 are straightly aligned in the vertical direction in the drawing, like the dots Y1, K1, C1, and M1. This also applies to the dots Y3, K3, and C3. However, when the color shift takes place, the dots M2 and C3 are deviated from the position where they should be, as shown in FIG. 8.

For example, when a thick paper is transported, the transporting force has to be increased, by increasing the force for holding the recording sheet between the transport roller pair (nip pressure), compared with the case where a thin paper is transported. However, increasing the nip pressure leads to an increase in load imposed on the recording sheet when entering into the nip region. Therefore, the transport speed is more likely to fluctuate, especially when the thick paper is transported.

In the aforementioned existing image forming apparatuses, the recording sheet is warped, to cause the recording sheet itself to absorb the fluctuation in transport speed. However, forming the warp may cause additional fluctuation in transport speed. Moreover, in the case where the warp is formed when a part of the recording sheet still remains in the printing position, the color shift may become more likely to be incurred.

According to the foregoing embodiment, in contrast, the follower roller 163 includes the plurality of rotating bodies 163A, unlike a conventional roller continuously extending in the width direction of the recording sheet P and having a smooth outer circumferential surface, and the nip region N is defined between the plurality of rotating bodies 163A and the drive roller 162. Accordingly, each of the rotating bodies 163A is subjected to a small load, and the load imposed on the recording sheet P at the time of entering into the nip region N is alleviated. Therefore, the fluctuation in transport speed can be more effectively suppressed, compared with the case of the existing apparatuses, and resultantly the occurrence of image degradation can be prevented. In addition, a high-load sheet such as a thick paper, for which sufficient transporting force has to be secured, can also be stably transported.

Further, the rotation speed of the drive roller 162 is increased, after the arrival of the recording sheet P at the detecting position, where the recording sheet P is immediately before entering into the nip region N, and until the predetermined period T elapses. Such an arrangement contributes to stabilizing the transport speed of the recording sheet P, thereby further ensuring that the occurrence of image degradation is suppressed. For example, the transport speed of the recording sheet P, a part of which still remains in the printing position of the image forming device 12 when the leading edge has entered into the nip region N, can be more effectively stabilized.

The follower roller 163 is located so as to make contact with the printed face of the recording sheet P, and therefore the ink on the recording sheet P may stick to the outer circumferential surface of the rotating body 163A. However, since each of the rotating bodies 163A is only subjected to a small load, the amount of the ink stuck thereto (ink stain) can be minimized.

Further, since the outer circumferential portion of the rotating body 163A is fitted in the corresponding annular groove 162B of the drive roller 162, the ink stuck to the outer circumferential surface of the rotating body 163A can be prevented from sticking to the outer circumferential surface of the drive roller 162. Therefore, the ink stuck to the rotating body 163A can be prevented from sticking to the face of the recording sheet P opposite to the printed face, via the drive roller 162.

As another embodiment, the controller 100 may set the second rotation speed, with respect to each of the thicknesses of the recording sheet P, so that the rotation speed of the transport roller pair 161 is increased, with the increase in thickness of the recording sheet P. In other words, the controller 100 may set the second rotation speed, such that the rotation speed of the drive roller 162 becomes faster, the thicker the recording sheet P is. In this case, the rotation speed can be more appropriately adjusted, depending on the thickness of the recording sheet P.

As a specific example, when a thinnest value is inputted by the user through the operation device 47, as the thickness of the recording sheet P, the controller 100 sets the rotation speed of the drive roller 162 to be faster than the first rotation speed by 0.1%, as the second rotation speed, and when a thickest acceptable value is inputted by the user as the thickness of the recording sheet P, the controller 100 sets the rotation speed of the drive roller 162 to be faster than the first rotation speed by 8.01%, as the second rotation speed.

The disclosure may be modified in various manners, without limitation to the foregoing embodiment. For example, although the image forming device 12 forms an image on the recording sheet P by ink jet printing in the foregoing embodiment, an electrophotographic method may be adopted instead, to form an image on the recording sheet P using a developing agent containing a toner. Further, the configurations of the foregoing embodiment, described with reference to FIG. 1 to FIG. 8, are merely exemplary, and in no way intended to limit the disclosure to those configurations.

While the present disclosure has been described in detail with reference to the embodiments thereof, it would be apparent to those skilled in the art the various changes and modifications may be made therein within the scope defined by the appended claims.

What is claimed is:

1. An image forming apparatus comprising:
an image forming device that forms an image on a recording medium, at a predetermined printing position;
a transport member that transports the recording medium through the printing position;
a transport roller pair including a drive roller, and a follower roller that defines a nip region in collaboration with the drive roller, and configured to transport the recording medium by holding the recording medium in the nip region;
an arrival sensor that detects arrival of the recording medium at a predetermined detecting position, where the recording medium is immediately before entering into the nip region;
a first drive source that drives the transport member;
a second drive source connected to a drive roller, and configured to drive the transport roller pair, the second drive source being independent from the first drive source; and
a controller that controls rotation speed of the transport member and the transport roller pair, by controlling operation of the first drive source and the second drive source,
wherein the transport roller pair is located downstream of the printing position in a transport direction of the recording medium, at a position where a leading edge in the transport direction, of the recording medium passing through the printing position, enters into the nip region,
the controller is configured to:
set the rotation speed of the transport member and the transport roller pair to predetermined first rotation speed; and
set the rotation speed of the drive roller to predetermined second rotation speed faster than the first rotation speed, for a predetermined period after the arrival sensor has detected the arrival of the recording medium, transported at the first rotation speed by the transport member, at the detecting position.

2. The image forming apparatus according to claim 1,
wherein one of the drive roller and the follower roller is in contact with a back face of a printed face of the recording medium, and the other roller is in contact with the printed face,
the one roller includes a plurality of annular grooves formed on an outer circumferential surface in a circumferential direction, and spaced from each other in an extending direction of a rotary shaft of the one roller, and
the other roller includes a plurality of thin rotating bodies, respectively opposed to the plurality of annular grooves so as to define a nip region with the plurality of annular grooves, and having a thickness that allows the rotating body to fit in the annular groove.

3. The image forming apparatus according to claim 1,
wherein the controller sets the second rotation speed, such that the rotation speed of the drive roller becomes faster, the thicker the recording medium is.

4. The image forming apparatus according to claim 1,
wherein the image forming device forms an image on the recording medium, by an ink jet printing method.

5. The image forming apparatus according to claim 1,
wherein the controller adjusts nip pressure in the nip region, such that the nip pressure is increased with an increase in thickness of the recording medium.
